(19) United States
(12) Patent Application Publication
(10) Pub. No.: US 2015/0169979 A1
(43) Pub. Date: Jun. 18, 2015

(54) TRAJECTORY MODELING APPARATUS AND METHOD BASED ON TRAJECTORY TRANSFORMATION

(71) Applicant: ELECTRONICS AND TELECOMMUNICATIONS RESEARCH INSTITUTE, Daejeon (KR)

(72) Inventors: Jong Gook KO, Daejeon (KR); Jin Woo CHOI, Seoul (KR); Ki Young MOON, Daejeon (KR); Jang Hee YOO, Daejeon (KR)

(73) Assignee: ELECTRONICS AND TELECOMMUNICATIONS RESEARCH INSTITUTE, Daejeon (KR)

(21) Appl. No.: 14/333,927

(22) Filed: Jul. 17, 2014

(30) Foreign Application Priority Data
Dec. 18, 2013 (KR) 10-2013-0158320

(51) Int. Cl. G06K 9/46

(52) U.S. Cl. CPC G06K 9/4604

(57) ABSTRACT

Provided is a trajectory modeling apparatus and method based on trajectory transformation which models a trajectory and compares a trajectory of an object and the modeled trajectory. The trajectory modeling apparatus includes an image input unit configured to receive an input image, an object trajectory generating unit configured to trace an object included in the input image to generate a trajectory of the object, a trajectory model generating unit configured to generate a trajectory model according to a directionality of the trajectory of the object by using the trajectory of the object, and a trajectory analyzing unit configured to analyze a trajectory of a target included in a test image by using the trajectory model to determine whether a behavior of the target is normal, based on the target trajectory analysis result.

### CROSS-REFERENCE TO RELATED APPLICATIONS

This application claims priority under 35 U.S.C. §119 to Korean Patent Application No. 10-2013-0158320, filed on Dec. 18, 2013, the disclosure of which is incorporated herein by reference in its entirety.

### TECHNICAL FIELD

The present invention relates to a trajectory modeling apparatus and method based on trajectory transformation which models a trajectory and compares a trajectory of an object and the modeled trajectory.

### BACKGROUND

Closed-circuit televisions (CCTVs) are variously used for industry, education, medicine, traffic control, and disaster prevention. As the distribution of CCTVs is rapidly expanded, the demand for an intelligent surveillance service that stores and analyzes an image captured by a CCTV to detect an abnormal behavior is increasing.

An intelligent image surveillance system fundamentally monitors behaviors of objects by using a video image, performs an object detecting and tracing function, and finally detects abnormal behavior patterns of objects.

Trajectory information of an object is information that is the most used for detecting an abnormal behavior pattern.

Trajectory modeling methods of the related art perform modeling of a normal trajectory by clustering trajectories based on a similarity of a spatial distance and a moving speed for modeling a trajectory, and compare spatial distances of a generated model and a newly input trajectory to determine normality or abnormality.

However, in the related art, when a newly input trajectory is within a threshold distance from a learned model, it is not easy to detect various types of abnormal behaviors such as front and rear movements, zigzag movement, and wandering, and it is difficult to determine one-way movement in consideration of a traveling direction of a trajectory that travels in a forward or reverse direction in a (x, y) space.

### SUMMARY

Accordingly, the present invention provides a trajectory modeling apparatus and method based on trajectory transformation which transform the existing trajectory with respect to a (x, y) space into another coordinate space, additionally model the trajectory with respect to the transformed coordinate space, and analyze a traveling direction and various directionalities of the trajectory, thereby detecting an abnormal behavior.

In one general aspect, a trajectory modeling apparatus based on trajectory transformation includes: an image input unit configured to receive an input image; an object trajectory generating unit configured to trace an object included in the input image received by the image input unit to generate a trajectory of the object; a trajectory model generating unit configured to generate a trajectory model according to a directionality of the trajectory of the object by using the trajectory of the object generated by the object trajectory generating unit; and a trajectory analyzing unit configured to analyze a trajectory of a target included in a test image received by the image input unit by using the trajectory model generated by the trajectory model generating unit, and determine whether a behavior of the target is normal, based on the target trajectory analysis result.

In another general aspect, a trajectory modeling method based on trajectory transformation includes: receiving a test image, and generating a trajectory of a target included in the test image; comparing the generated trajectory of the target and a trajectory model with respect to a 2D coordinate space; transforming the trajectory of the target into a transformation trajectory with respect to a transformation coordinate space; comparing the transformation trajectory of the target and a transformation trajectory model with respect to the transformation coordinate space; and determining whether a behavior of the target is normal, based on the comparison result of the trajectory of the target and the trajectory model with respect to the 2D coordinate space and the comparison result of the trajectory of the target and the transformation trajectory model with respect to the transformation coordinate space.

Other features and aspects will be apparent from the following detailed description, the drawings, and the claims.

### BRIEF DESCRIPTION OF THE DRAWINGS

FIG. 1 is a block diagram illustrating a trajectory modeling apparatus based on trajectory transformation according to the present invention.

FIG. 2 is exemplary diagrams illustrating a normal trajectory and abnormal wandering of an input image.

FIG. 3 is conceptual diagrams illustrating trajectory modeling based on a Hausdorff distance according to the present invention.

FIG. 4 is exemplary diagrams illustrating a trajectory on (x, y) coordinates of an input image according to the present invention.

FIG. 5 is graphs showing a transformed trajectory on transformation coordinates of a trajectory on the (x, y) coordinates, according to the present invention.

FIGS. 6A, 6B and 6C are a flowchart illustrating a trajectory modeling method based on trajectory transformation according to the present invention.

FIG. 7 is a flowchart illustrating an operation of detecting an abnormal behavior by using trajectory modeling based on trajectory transformation, according to the present invention.

### DETAILED DESCRIPTION OF EMBODIMENTS

Hereinafter, embodiments of the present invention will be described in detail with reference to the accompanying drawings.

In the present specification, an object is construed as denoting a target object included in an input image which is a trace target of a trajectory for generating a trajectory model, and a target is construed as denoting an object included in an input image which is an analysis target for determining a normal behavior.

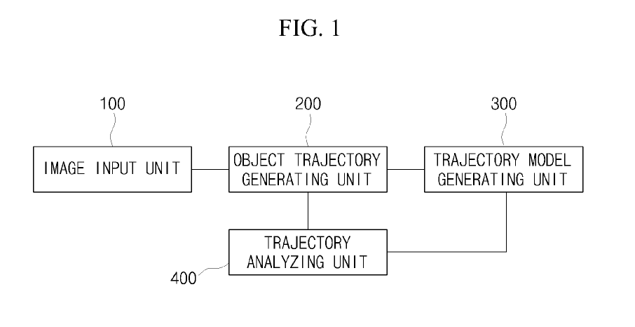

FIG. 1 is a block diagram illustrating a trajectory modeling apparatus based on trajectory transformation according to the present invention. Referring to FIG. 1, the trajectory modeling apparatus based on trajectory transformation includes an image input unit 100 that receives an input image, an object trajectory generating unit 200 that traces an object included in the input image received by the image input unit 100 to generate a trajectory of the object, a trajectory model generating unit 300 that generates a trajectory model according to a directionality of the trajectory of the object by using the trajectory of the object generated by the object trajectory generating unit 300, and a trajectory analyzing unit 400 that analyzes a trajectory of a target included in a test image received by the image input unit 100 by using the trajectory model generated by the trajectory model generating unit 300, and determines whether a behavior of the target is normal, based on the target trajectory analysis result.

The image input unit 100 receives a plurality of input images. The object trajectory generating unit 200 traces a plurality of objects respectively included in the plurality of input images received by the image input unit 100, and generates trajectories of the objects to generate the trajectories of the traced objects in a (x, y) coordinate space (which is a two-dimensional (2D) coordinate space) according to the input images received by the image input unit 100. The trajectory model generating unit 300 generates a trajectory model by using the trajectories of the plurality of objects.

The trajectory model generating unit 300 calculates a similarity between the trajectories of the plurality of objects generated by the object trajectory generating unit 200, and generates the trajectory model, based on the calculated similarity.

The trajectory model generating unit 300 calculates the similarity by using a Hausdorff distance between the trajectories of the plurality of objects generated by the object trajectory generating unit 200, and clusters a plurality of trajectories of which a similarity is within a predetermined threshold value.

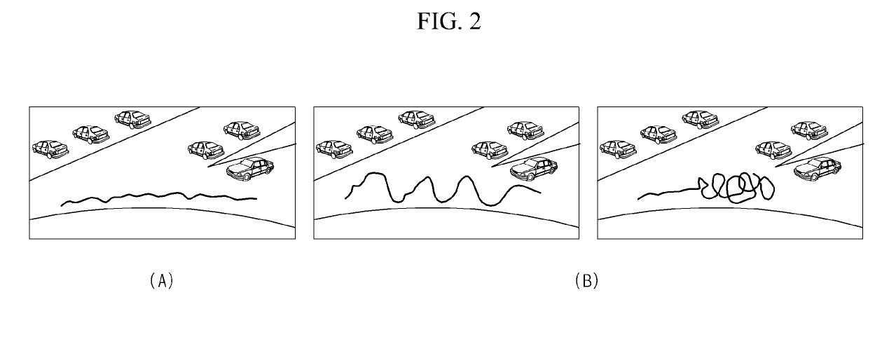

FIG. 2 is exemplary diagrams illustrating a normal trajectory and abnormal wandering of an input image.

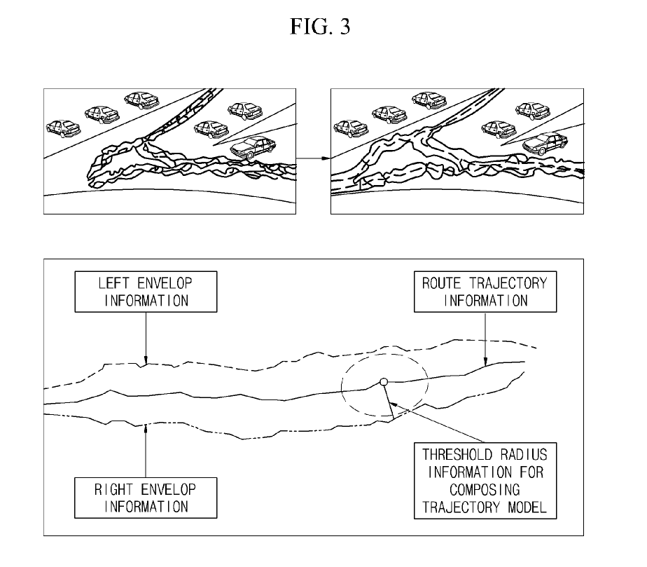

FIG. 3 is conceptual diagrams illustrating trajectory modeling based on a Hausdorff distance according to the present invention. Referring to FIG. 3, the trajectory model generating unit 300 generates a route trajectory that is the center of the clustered trajectories, and calculates envelope information with respect to the route trajectory and threshold radius information of a trajectory model for each point (node) of the route trajectory.

The Hausdorff distance is a concept that defines a distance between two objects in image recognition or 2D computer graphics, and is applied to a method of finding a representative node.

In calculating the closest distance between two objects, when one node is a reference, it cannot be considered that a point of one object is always close to points of the other object. Therefore, the Hausdorff distance is a concept that is proposed to be suitable for determining a distance (a correlation) between two objects, and is applied to a method of fining a representative node by using the maximum distance having the same result under an arbitrary combination.

The Hausdorff distance is calculated by using the following Equation (1). In Equation (1), A and B denote two trajectories. The Hausdorff distance is calculated by using Equation (1) for calculating a distance of nodes (a, b) composing the two trajectories.

$$h ( A , B ) = {max}_{a ∈ A} \{ {min}_{b ∈ B} \{ d ( a , b ) \} \} \qquad ( 1 )$$

Referring to FIG. 3, the trajectory model generating unit 300 according to the present invention forms a route trajectory, which is calculated by using the Hausdorff distance between trajectories, and envelopees (a left envelopee and a right envelope) of the route trajectory.

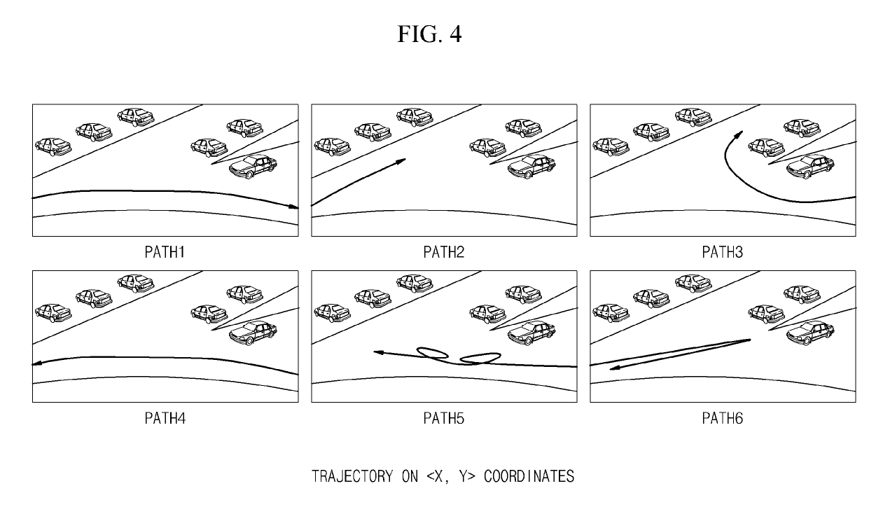

FIG. 4 is exemplary diagrams illustrating a trajectory on (x, y) coordinates of an input image according to the present invention. Referring to FIG. 4, a trajectory 1 (path1) to a trajectory 6 (path6) illustrate trajectories of an object that moves in an arrow direction.

The trajectory model generating unit 300 according to the present invention transforms a trajectory of an object, such as the trajectory 1 (path1) to the trajectory 6 (path6), into a coordinate value on a first axis (an x axis), which constitutes a node composing the trajectory of the object and a 2D coordinate space (x, y), to generate a first transformation trajectory model with respect to a first transformation coordinate (point_num, delta X) space, and transforms the trajectory of the object into a coordinate value on a second axis (a y axis), which constitutes the node composing the trajectory of the object and the 2D coordinate space (x, y), to generate a second transformation trajectory model with respect to a second transformation coordinate (point_num, delta Y) space.

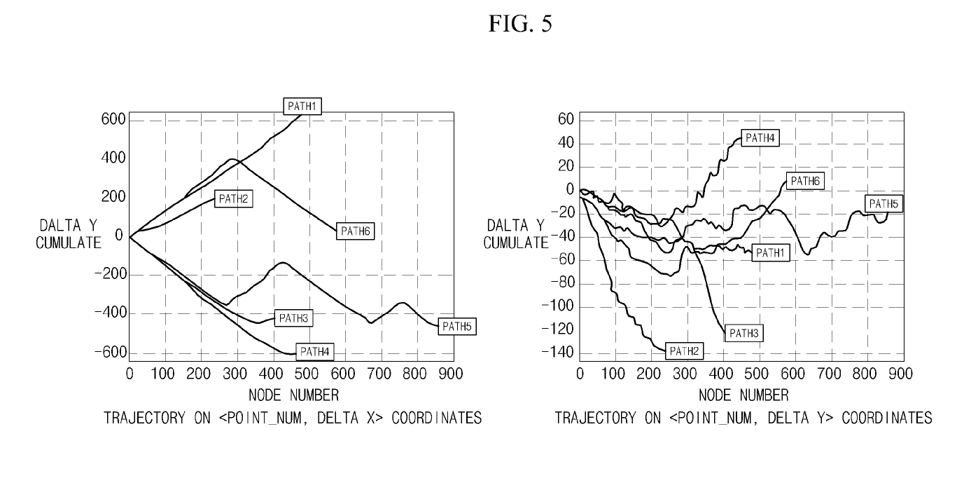

FIG. 5 is graphs showing a transformed trajectory on transformation coordinates of a trajectory on the (x, y) coordinates, according to the present invention, and shows a transformation trajectory which is obtained by transforming a trajectory into transformation coordinate spaces (point_num, delta X) and (point_num, delta Y) by using random walk.

A trajectory is transformed into a transformation trajectory by using the following Equations (2) and (3). In Equations (2) and (3), Xi denotes a random variable and is a difference between x coordinate values on adjacent nodes composing the trajectory with respect to the 2D coordinate space (x, y), and Yi denotes a random variable and is a difference between y coordinate values on the adjacent nodes composing the trajectory with respect to the 2D coordinate space (x, y). A Delta X value and a Delta Y value are calculated by summating accumulated values of difference values of Xi and Yi.

DeltaX_{—}Sₙ=Σᵢ₌₀ⁿXᵢ,Xᵢ=xᵢ−xᵢ₋₁ (2)

DeltaY_{—}Sₙ=Σᵢ₌₀ⁿYᵢ,Yᵢ=yᵢ−yᵢ₋₁ (3)

Referring to FIG. 4, when directionality is not considered, the trajectory 1 (path1) and the trajectory 4 (path4) are classified into the same trajectory model with respect to the 2D coordinate space (x, y). However, referring to FIG. 5 that is a transformation trajectory graph according to the present invention, the trajectory 1 (path1) and the trajectory 4 (path4) are classified into different trajectory models with respect to the (point_num, delta Y) coordinate space.

When a transformation trajectory model is generated by separating an x coordinate value and a y coordinate value that compose coordinates of a trajectory with respect to the 2D coordinate space (x, y), a trajectory model with the consideration of a traveling direction of an object may be generated by analyzing a directionality of a trajectory of the object.

The object trajectory generating unit 200 generates the trajectory of the target included in the test image received by the image input unit 100, and transforms the trajectory of the target with respect to a transformation coordinate space to generate a transformation trajectory of the target.

The object trajectory generating unit 200 compares the trajectory of the target and the trajectory model with respect to the 2D coordinate space which is generated by the trajectory model generating unit 300, and compares the transformation trajectory model with respect to the transformation coordinate space and the transformation trajectory of the target to determine whether the trajectory of the target is normal or abnormal.

When a distance between the trajectory model and the trajectory of the target or a distance between the transformation trajectory model and the transformation trajectory of the target is greater than a predetermined threshold value, the trajectory analyzing unit 400 determines a movement of the target as an abnormal behavior.

In another embodiment, when a distance between trajectories of the object is greater than the predetermined threshold value, the trajectory model generating unit 300 generates a new trajectory model.

When a distance value between a newly input trajectory and the existing trajectory model is greater than a specific threshold value, the trajectory model generating unit 300 generates a new trajectory model based on coordinate and size information of the newly input trajectory without merging the newly input trajectory into the existing trajectory model.

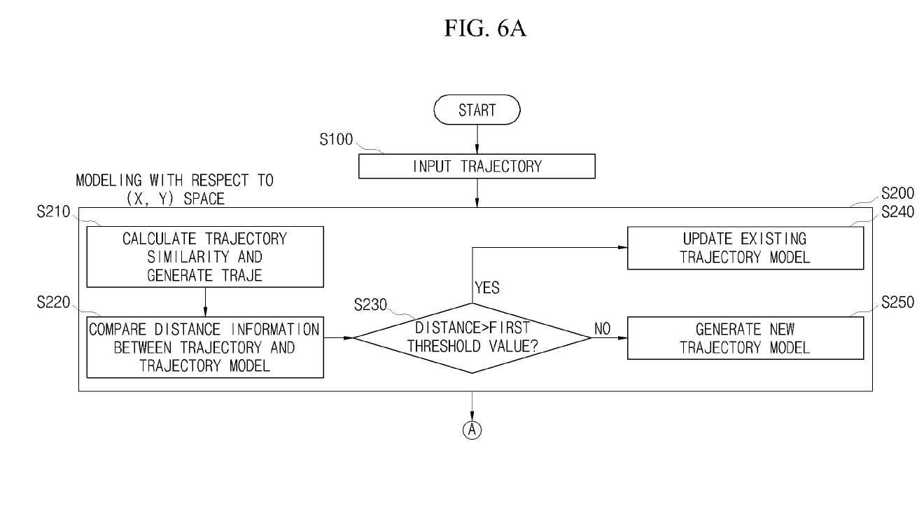

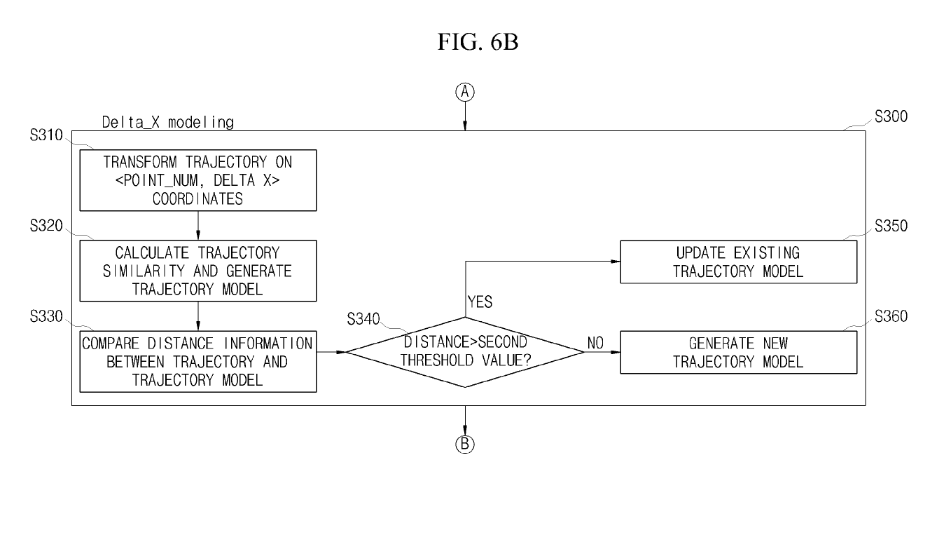

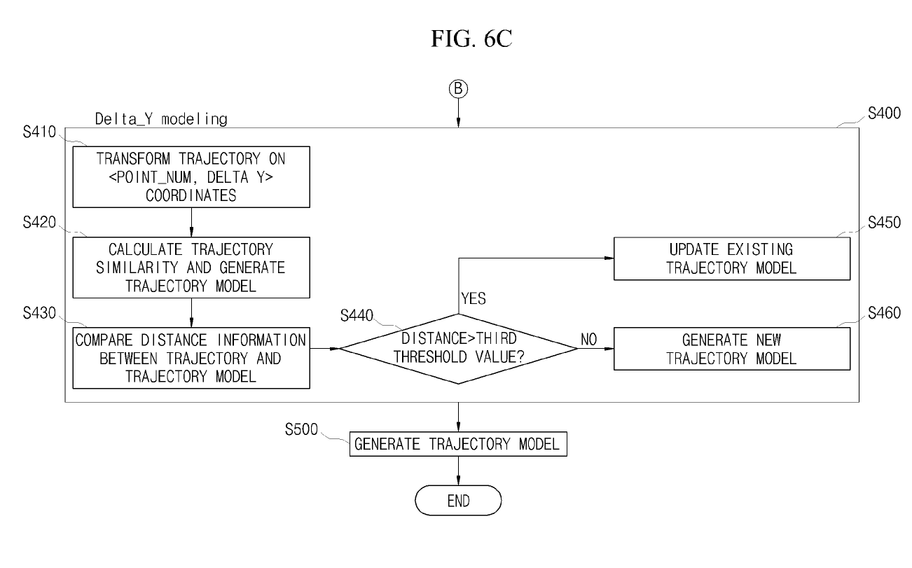

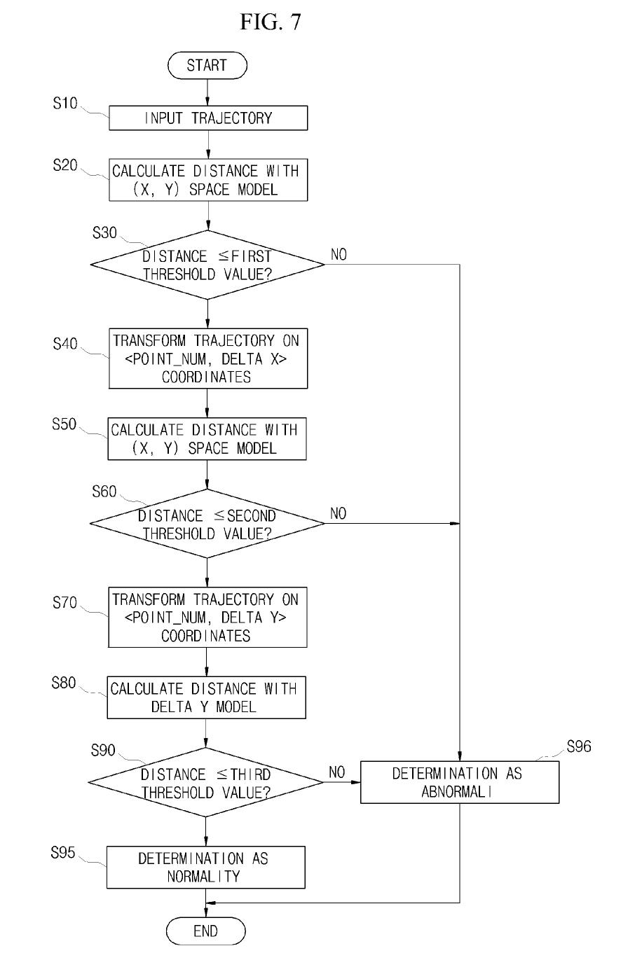

FIGS. 6A, 6B and 6C are a flowchart illustrating a trajectory modeling method based on trajectory transformation according to the present invention. FIG. 7 is a flowchart illustrating an operation of detecting an abnormal behavior by using trajectory modeling based on trajectory transformation, according to the present invention.

Referring to FIGS. 6A, 6B, 6C and 7, the trajectory modeling method based on trajectory transformation according to the present invention includes: operation S10 that receives an input image, and generates a trajectory of a target included in a test image; operation S20 that compares the generated trajectory of the target and a trajectory model with respect to a 2D coordinate space; operations S50 and S70 that transform the trajectory of the target into a transformation trajectory with respect to a transformation coordinate space; operations S60 and S90 that compare the transformation trajectory of the target and a transformation trajectory model with respect to the transformation coordinate space; and operations S100 and S110 that determine whether a behavior of the target is normal, based on the comparison result of the trajectory of the target and the trajectory model with respect to the 2D coordinate space and the comparison result of the trajectory of the target and the transformation trajectory model with respect to the transformation coordinate space.

The trajectory modeling method based on trajectory transformation according to the present invention further includes operations S200 to S400 that generate the trajectory model with respect to the 2D coordinate space and the transformation trajectory model with respect to the transformation coordinate space.

Operations S200 to S400, which generate the trajectory model with respect to the 2D coordinate space and the transformation trajectory model with respect to the transformation coordinate space, includes: operation S210 that receives an input image, and traces an object included in the input image to generate a trajectory of the object with respect to the 2D coordinate space; operation S220 that calculates a distance between trajectories of the object; operation S250 that clusters a trajectory, in which the calculated distance is equal to or less than a predetermined threshold value, to generate a trajectory model with respect to the 2D coordinate space; operations S310 and S410 that transform the trajectory of the object into coordinate values of a first axis and a second axis which constitute the 2D coordinate space composing the trajectory of the object with respect to the 2D coordinate space, and generate a transformation trajectory with respect to the transformation coordinate space; operations S320 and S420 that calculate a distance between transformation trajectories with respect to the transformation coordinate space; and operations S360 and S460 that cluster a transformation trajectory, in which the calculated distance is equal to or less than a predetermined value, to generate a transformation trajectory model with respect to the transformation coordinate space.

Operation S250 that generates the trajectory model with respect to the 2D coordinate space and operations S360 and S460, which generate the transformation trajectory model with respect to the transformation coordinate space, calculates the distance between the trajectories and the distance between the transformation trajectories by using a Hausdorff distance between the trajectory and transformation trajectory of the object.

The trajectory modeling method based on trajectory transformation according to the present invention further includes operations S240, S350 and S450 that, when the distance between the trajectories and the distance between the transformation trajectories are greater than a predetermined threshold value (a first threshold value) and a predetermined value (a second threshold value or a third threshold value), generate a new trajectory model and a new transformation trajectory model.

When a distance value between the new trajectory model and the new transformation trajectory model is greater than a specific threshold value, the trajectory modeling method generates a new trajectory model based on coordinate and size information of newly input trajectory information, and adds the newly generated trajectory model into the existing trajectory model set.

In operations S250, S360 and S460, when the newly input trajectory information is equal to or less than the predetermined threshold value (the first threshold value) and the predetermined value (the second threshold value or the third threshold value), the trajectory modeling method merges the newly input trajectory information into the existing trajectory model, calculates average trajectory position information by using the size and coordinate information of the newly input trajectory information merged into the existing trajectory model, and updates model trajectory information. The trajectory modeling method compares envelope (a left envelope and a right envelope) information of the trajectory model and position information of a newly input trajectory, and when the newly input trajectory deviates from an envelope, the trajectory modeling method updates envelope information to new envelope information by using the position information of the newly input trajectory.

In an operation of determining whether the behavior of the target is normal, In operation S96, when at least one of a distance between the trajectory of the target and the trajectory model and a distance between the transformation trajectory of the target and the transformation trajectory model is equal to or less than the specific threshold value, the trajectory modeling method determines the trajectory of the target as an abnormal behavior in operation S96.

In an operation of determining whether the behavior of the target is normal, the trajectory modeling method compares the distance between the trajectory of the target and the trajectory model with the threshold value in operation S30, and compares the distance between the transformation trajectory of the target and the transformation trajectory model with the second or third threshold value in operations S60 and S90. When the distance between the trajectory of the target and the trajectory model is equal to or less than the threshold value, or the distance between the transformation trajectory of the target and the transformation trajectory model is equal to or less than the second or third threshold value, the trajectory modeling method determines a movement of the target as an abnormal behavior in operation S95.

The distance between the trajectory of the target and the trajectory model and the distance between the transformation trajectory of the target and the transformation trajectory model are calculated by using the following Equation (4), when each of the calculated distances is greater than a threshold value, the movement of the target is determined as the abnormal behavior.

Dist=min(min(IN,model)) (4)

where IN denotes a trajectory of a target, and model denotes a trajectory model or a transformation trajectory model.

As described above, the trajectory modeling apparatus and method based on trajectory transformation according to the present invention transform an acquired trajectory with respect to the (x, y) space into a trajectory on the transformation coordinates to perform modeling of the trajectory.

Furthermore, the trajectory modeling apparatus and method analyze a traveling direction and various directionalities of a trajectory included in an input image by using a generated trajectory model, and analyze the traveling direction and various directionalities of the trajectory on the transformation coordinates, thereby reliably detecting an abnormal behavior.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A trajectory modeling apparatus based on trajectory transformation, the trajectory modeling apparatus comprising:
an image input unit configured to receive an input image;
an object trajectory generating unit configured to trace an object included in the input image received by the image input unit to generate a trajectory of the object;
a trajectory model generating unit configured to generate a trajectory model according to a directionality of the trajectory of the object by using the trajectory of the object generated by the object trajectory generating unit; and
a trajectory analyzing unit configured to analyze a trajectory of a target included in a test image received by the image input unit by using the trajectory model, and determine whether a behavior of the target is normal, based on the target trajectory analysis result.

2. The trajectory modeling apparatus of claim 1, wherein the object trajectory generating unit generates a trajectory of the traced object with respect to a 2D coordinate space according to the input image received by the image input unit.

3. The trajectory modeling apparatus of claim 2, wherein the trajectory model generating unit calculates a similarity between trajectories of the object generated by the object trajectory generating unit to generate the trajectory model.

4. The trajectory modeling apparatus of claim 3, wherein the trajectory model generating unit calculates the similarity by using a Hausdorff distance between the trajectories of the object generated by the object trajectory generating unit, and clusters a trajectory, in which the similarity is within a predetermined threshold value, to generate a trajectory model with respect to the 2D coordinate space.

5. The trajectory modeling apparatus of claim 4, wherein when the Hausdorff distance between the trajectories of the object is greater than a predetermined threshold value, the trajectory model generating unit generates a new trajectory model.

6. The trajectory modeling apparatus of claim 4, wherein the trajectory model generating unit transforms a node composing the generated trajectory of the object into coordinate values of a first axis and a second axis, which constitute the 2D coordinate space, and generates a transformation trajectory with respect to a transformation coordinate space to generate a transformation trajectory model with respect to the transformation coordinate space.

7. The trajectory modeling apparatus of claim 6, wherein the object trajectory generating unit generates the trajectory of the target included in the test image received by the image input unit, and transforms the trajectory of the object with respect to the transformation coordinate space to generate a transformation trajectory of the target.

8. The trajectory modeling apparatus of claim 7, wherein the trajectory analyzing unit compares the trajectory of the target included in the test image and the trajectory model with respect to the 2D coordinate space, and compares the transformation trajectory of the target and the transformation trajectory model to determine whether the trajectory of the target is normal or abnormal.

9. The trajectory modeling apparatus of claim 8, wherein when a distance between the trajectory model and the trajectory of the target or a distance between the transformation trajectory model and the transformation trajectory of the target is greater than a predetermined threshold value, the trajectory analyzing unit determines a movement of the target as an abnormal behavior.

10. A trajectory modeling method based on trajectory transformation, the trajectory modeling method comprising:
receiving a test image, and generating a trajectory of a target included in the test image;
comparing the generated trajectory of the target and a trajectory model with respect to a 2D coordinate space;
transforming the trajectory of the target into a transformation trajectory with respect to a transformation coordinate space;
comparing the transformation trajectory of the target and a transformation trajectory model with respect to the transformation coordinate space; and
determining whether a behavior of the target is normal, based on the comparison result of the trajectory of the target and the trajectory model with respect to the 2D coordinate space and the comparison result of the trajectory of the target and the transformation trajectory model with respect to the transformation coordinate space.

11. The trajectory modeling method of claim 10, further comprising generating the trajectory model with respect to the 2D coordinate space and the transformation trajectory model with respect to the transformation coordinate space.

12. The trajectory modeling method of claim 11, wherein the generating of the trajectory model and the transformation trajectory model comprises:
receiving an input image, and tracing an object included in the input image to generate a trajectory of the object with respect to the 2D coordinate space;
calculating a distance between trajectories of the object, and clustering a trajectory, in which the calculated distance is equal to or less than a predetermined threshold value, to generate a trajectory model with respect to the 2D coordinate space;
transforming the trajectory of the object into coordinate values of a first axis and a second axis which constitute the 2D coordinate space of a node composing the trajectory of the object with respect to the 2D coordinate space, and generating a transformation trajectory with respect to the transformation coordinate space; and
calculating a distance between transformation trajectories with respect to the transformation coordinate space, and clustering a transformation trajectory, in which the calculated distance is equal to or less than a predetermined value, to generate a transformation trajectory model with respect to the transformation coordinate space.

13. The trajectory modeling method of claim 12, wherein the generating of the trajectory model and the transformation trajectory model comprises calculating the distance between the trajectories and the distance between the transformation trajectories by using a Hausdorff distance between the trajectory and transformation trajectory of the object.

14. The trajectory modeling method of claim 13, further comprising, when the distance between the trajectories and the distance between the transformation trajectories is greater than a predetermined threshold value and a predetermined value, generating a new trajectory model and a new transformation trajectory model.

15. The trajectory modeling method of claim 13, further comprising, when the distance between the trajectories and the distance between the transformation trajectories is equal to or less than a predetermined threshold value and a predetermined value, calculating average trajectory position information of each of the trajectory and the transformation trajectory, and updating the trajectory model and the transformation trajectory model by using the calculated average trajectory position information.

16. The trajectory modeling method of claim 10, wherein the determining of whether a behavior of the target is normal comprises, when at least one of a distance between the trajectory of the target and the trajectory model and a distance between the transformation trajectory of the target and the transformation trajectory model is equal to or less than a threshold value, determining the trajectory of the target as an abnormal behavior.
